(19) United States
(12) Patent Application Publication
(10) Pub. No.: US 2025/0132942 A1
(43) Pub. Date: Apr. 24, 2025

(54) MANAGING RECEPTION OF MULTICAST AND BROADCAST SERVICES

(71) Applicant: GOOGLE LLC, Mountain View, CA (US)

(72) Inventor: Chih-Hsiang Wu, Taoyuan City (TW)

(21) Appl. No.: 18/681,511

(22) PCT Filed: Aug. 5, 2022
(86) PCT No.: PCT/US2022/039534

§ 371 Date: Feb. 5, 2024

Related U.S. Application Data
(60) Provisional application No. 63/203,979, filed on Aug. 5, 2021.

(51) Int. Cl. H04L 12/18; H04W 68/02; H04W 72/30; H04W 76/27

(52) U.S. Cl. CPC H04L 12/185; H04W 68/02; H04W 72/30; H04W 76/27

(57) ABSTRACT

To manage reception of Multicast and Broadcast Services (MBS) data, a user equipment (UE) receives, from a radio access network (RAN), a paging message including an MBS session identifier (ID), the MBS session ID including a Temporary Mobile Group Identity (TMGI); and initiates reception of MBS in response to the paging message.

### FIELD OF THE DISCLOSURE

This disclosure relates to wireless communications and, more particularly, to enabling transmission and/or reception of one or more multicast and/or broadcast services (MBS).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier, 3GPP has proposed that for Release 17, a 5G NR base station can provide multicast and/or broadcast services (MBS) to UEs that can be useful in many content delivery applications, such as transparent IPv4/IPv6 multicast delivery, IPTV, software delivery over wireless, group communications, IoT applications, V2X applications, and emergency messages related to public safety.

To provide multicast and/or broadcast service (MBS), a base station can configure plural UEs with a common frequency resource (CFR) and a physical downlink control channel (PDCCH) configuration configuring a group common PDCCH. The base station can assign a group common radio network temporary identifier (RNTI) to these UEs to receive physical downlink shared channel (PDSCH) transmissions including MBS data packet(s). Then the base station can send a downlink control information (DCI) with a cyclic redundancy check (CRC) scrambled by the group common RNTI on a group common PDCCH to schedule a PDSCH transmission including MBS data packet(s).

However, it is not clear how the UE activates MBS reception upon receiving an MBS activation notification message.

### SUMMARY

An example embodiment of the techniques discussed below is a method in a UE for managing reception of Multicast and Broadcast Services (MBS) data. The method comprises receiving, from a radio access network (RAN), a paging message including an MBS session identifier (ID), the MBS session ID including a Temporary Mobile Group Identity (TMGI); and initiating reception of MBS in response to the paging message.

Another example embodiment of these techniques is a UE comprising one or more processors and configured to implement the method above.

### BRIEF DESCRIPTION OF THE DRAWINGS

FIG. 1A is a block diagram of an example wireless communication system in which a RAN and/or a UE implement the techniques of this disclosure for managing transmission and reception of MBS;

FIG. 1B is a block diagram of an example base station including a central unit (CU) and a distributed unit (DU) that can operate in the system of FIG. 1A;

FIG. 2 is a block diagram of an example protocol stack according to which the UE of FIG. 1A communicates with base stations;

FIG. 3A is an example message sequence in which a base station activates MBS transmission for an MBS session and one or more UEs operating an idle state activates MBS reception to receive the MBS session;

FIG. 3B is an example message sequence in which a base station activates MBS transmission for an MBS session and one or more UEs operating an inactive state activates MBS reception to receive the MBS session;

FIG. 4A-10 are flow diagrams of example methods for receiving a MBS, which can be implemented by a UE; and

FIG. 11 is a flow diagram depicting an example method that a RAN (e.g., the base station 104 or the CU 172) can implement to manage transmission of an MBS.

### DETAILED DESCRIPTION OF THE DRAWINGS

Generally speaking, the techniques of this disclosure allow UEs to receive MBS information via radio resources allocated by a base station of a RAN. To this end, the base station can configure different radio resources in one or multiple overlapping cells to multicast or broadcast MBS data (and associated control information) and/or unicast non-MBS data (and associated control information) with one or multiple UEs on the downlink (DL). Note that “transmit” by a base station may interchangeably refer to “multicast”, “broadcast”, and/or “unicast.” The base station can also unicast MBS data (and associated control information) to a UE on a dedicated DRB for the UE. The one or more multiple UEs can transmit non-MBS data to the base station on the uplink (UL).

Accordingly, a base station of this disclosure can configure one or more radio bearers to transmit MBS information (i.e., MBS data packets and/or control information) to a UE. A radio bearer that carries MBS information to the UE can be a unicast DRB (i.e., a dedicated DRB for the UE) or a multicast DRB (i.e., a DRB that may be shared by multiple UEs, also referred to as an MBS radio bearer or MRB). For example, the base station can transmit unicast configuration parameters or multicast configuration parameters to the UE to configure the UE to receive MBS information via a unicast DRB or a multicast DRB, respectively. As used in this disclosure, the term DRB may refer to a unicast DRB or a multicast DRB, unless specifically noted otherwise.

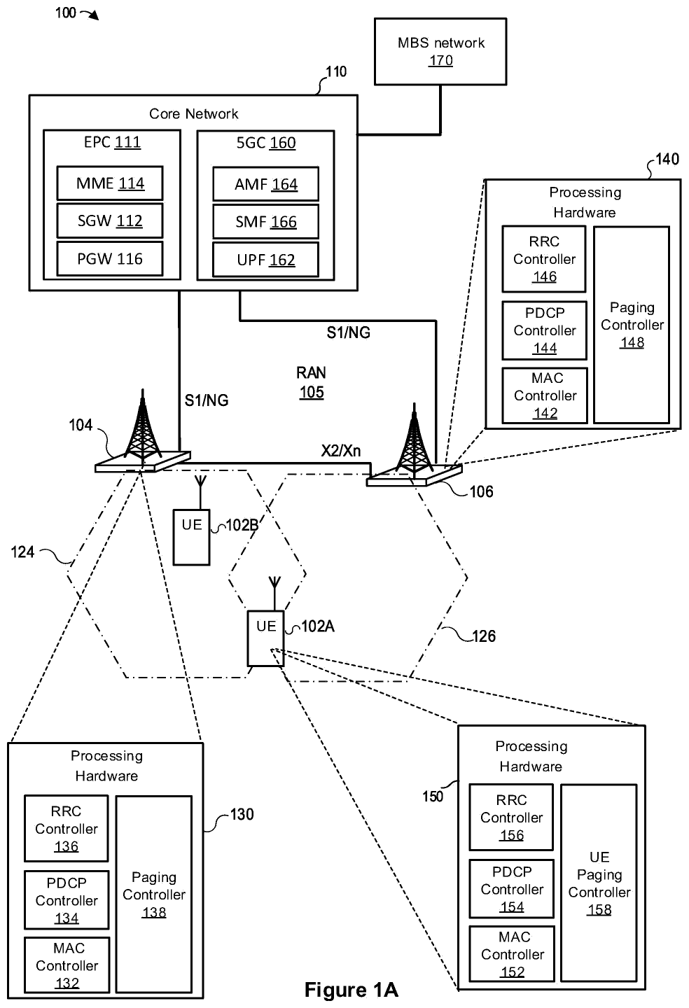

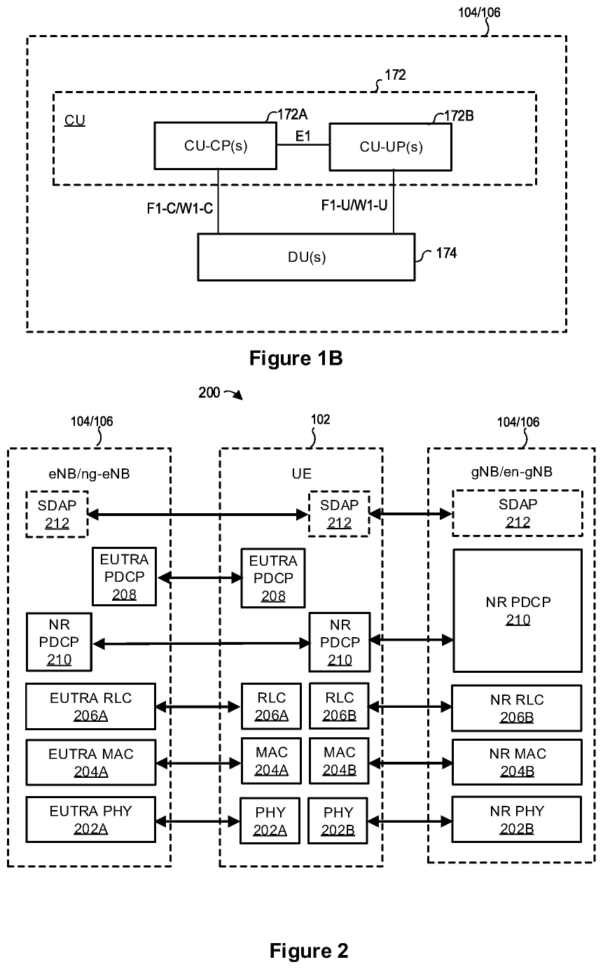

FIG. 1A depicts an example wireless communication system 100 that can implement MBS operation techniques of this disclosure. The wireless communication system 100 includes UE 102A and UE 102B, as well as base stations 104, 106A, 106B of a radio access network (RAN) (e.g., RAN 105) that are connected to a core network (CN) 110. To case readability, UE 102 is used herein to represent the UE 102A, the UE 102B, or both the UE 102A and UE 102B, unless otherwise specified. The base stations 104, 106A, 106B can be any suitable type, or types, of base stations, such as an evolved node B (eNB), a next-generation eNB (ng-eNB), a 5G Node B (gNB) or a 6G base station, for example. As a more specific example, the base station 104 can be an eNB or a gNB, and the base stations 106A and 106B can be gNBs.

The base station 104 supports a cell 124, the base station 106A supports a cell 126A, and the base station 106B supports a cell 126B. The cell 124 partially overlaps with both of cells 126A and 126B, such that the UE 102 can be in range to communicate with base station 104 while simultaneously being in range to communicate with base station 106A or 106B (or in range to detect or measure the signal from both base stations 106A and 106B). The overlap can make it possible for the UE 102 to hand over between cells (e.g., from cell 124 to cell 126A or 126B) or base stations (e.g., from base station 104 to base station 106A or base station 106B) before the UE 102 experiences radio link failure, for example. Moreover, the overlap allows the UE 102 to operate in dual connectivity (DC) with the RAN 105. For example, the UE 102 can communicate in DC with the base station 104 (operating as a master node (MN)) and the base station 106A (operating as a secondary node (SN)) and, upon completing a handover to base station 106B, can communicate with the base station 106B (operating as an MN). As another example, the UE 102 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 102 is in DC with the base station 104 and the base station 106A, the base station 104 operates as a master eNB (MeNB), a master ng-eNB (Mng-eNB), or a master gNB (MgNB), and the base station 106A operates as a secondary gNB (SgNB) or a secondary ng-eNB (Sng-eNB).

In non-MBS (i.e., unicast) operation, the UE 102 can use a radio bearer (e.g., a DRB or an SRB) that at different times terminates at an MN (e.g., the base station 104) or an SN (e.g., the base station 106). For example, after handover or SN change to the base station 106B, the UE 102 can use a radio bearer (e.g., a DRB or an SRB) that at different times terminates at the base station 106B. The UE 102 can apply one or more security keys when communicating on the radio bearer, in the uplink (UL) direction (i.e., from the UE 102 to a base station) and/or downlink (DL) direction (i.e., from a base station to the UE 102). In non-MBS operation, the UE 102 transmits data via the radio bearer on (i.e., within) an uplink BWP of a cell to the base station and/or receives data via the radio bearer on a DL BWP of the cell from the base station. The UL BWP can be an initial UL BWP or a dedicated UL BWP, and the DL BWP can be an initial DL BWP or a dedicated DL BWP. The UE 102 can receive paging, system information, public warning message(s), or a random access response on the DL BWP. In such non-MBS operation, the UE 102 can be in a connected state. Alternatively, the UE 102 can be in an idle or inactive state if the UE 102 supports small data transmission in the idle or inactive state.

In MBS operation, the UE 102 can use a radio bearer (e.g., a DRB or an MRB) that at different times terminates at an MN (e.g., the base station 104) or an SN (e.g., the base station 106A). For example, after handover or SN change to the base station 106B, the UE 102 can use a radio bearer (e.g., a DRB or an MRB) that at different times terminates at the base station 106B which can be an MN or SN. The base station can utilize the radio bearer to transmit application-level messages, such as security keys, to the UE 102. In some implementations, the base station (e.g., the MN or SN) can transmit MBS data over dedicated radio resources (i.e., the radio resources dedicated to the UE 102) to the UE 102 (e.g., via the DRB or MRB). In such implementations, the base station can apply one or more security keys to protect integrity of MBS data and/or encrypt MBS data and transmits the encrypted and/or integrity protected MBS data over the dedicated radio resources to the UE 102. Correspondingly, the UE 102 can apply the one or more security keys to decrypt MBS data and/or check integrity of the MBS data when receiving the MBS data on the radio bearer, in the downlink (from a base station to the UE 102) direction. In other implementations, the base station (e.g., the MN or SN) can transmit MBS data over common radio resources (i.e., the radio resources common to the UE 102 and other UE(s) such as common frequency resources (CFR)) or a DL BWP of a cell from the base station to the UE 102 (e.g., via the DRB or MRB). The DL BWP can be an initial DL BWP, a dedicated DL BWP, or an MBS DL BWP (i.e., a DL BWP specific for MBS or not for unicast). In such implementations, the base station can refrain from applying a security key to MBS data and transmit the MBS data on the radio bearer. Correspondingly, the UE 102 can omit applying a security key to MBS data received on the radio bearer. The UE 102 can apply an application-level security key, received from the CN 110 or an MBS server, to MBS data received on the radio bearer.

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation in FIG. 1A includes a base station MBS controller 132 that is configured to manage or control transmission of MBS information received from the CN 110 or an edge server. For example, the base station MBS controller 132 can be configured to support Radio Resource Control (RRC) configurations, procedures and messaging associated with MBS procedures, and/or to support the necessary operations (e.g., MBS activation notification), as discussed below. The processing hardware 130 can include a base station non-MBS controller 134 configured to manage or control one or more RRC configurations and/or RRC procedures when the base station 104 operates as an MN or SN during a non-MBS operation.

The base station 106A includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes a base station MBS controller 142 that is configured to manage or control transmission of MBS information received from the CN 110 or an edge server. For example, the base station MBS controller 142 can be configured to support RRC configurations, procedures and messaging associated with MBS procedures, and/or to support the necessary operations (e.g., MBS activation notification), as discussed below. The processing hardware 140 can include a base station non-MBS controller 144 configured to manage or control one or more RRC configurations and/or RRC procedures when the base station 106A operates as an MN or SN during a non-MBS operation. While not shown in FIG. 1A, the base station 106B can include processing hardware similar to the processing hardware 130 of the base station 104 or the processing hardware 140 of the base station 106A.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE MBS controller 152 that is configured to manage or control reception of MBS information. For example, the UE MBS controller 152 can be configured to support RRC configurations, procedures and messaging associated with MBS procedures, and/or to support the necessary operations (e.g., MBS activation notification), as discussed below. The processing hardware 150 can include a UE non-MBS controller 154 configured to manage or control one or more RRC configurations and/or RRC procedures in accordance with any of the implementations discussed below, when the UE 102 communicates with an MN and/or an SN during a non-MBS operation.

The CN 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106A can be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104, 106A, and 106B can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions. The UPF 162, AMF 164 and/or the SMF 166 can be configured to support MBS. For example, the SMF 166 can be configured to manage or control MBS transport, configure the UPF 162 and/or RAN 105 for MBS flows, and/or manage or configure MBS session(s) or PDU Session(s) for MBS for UE 102. The UPF 162 is configured to transfer MBS data packets to audio, video, Internet traffic, etc. to the RAN 105. The UPF 162 and/or SMF 166 can be configured for both unicast service and MBS, or for MBS only.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, the base station 106B can operate as an MeNB, an Mng-eNB, an MgNB, an SgNB, or an Sng-eNB, and the base station 106A can operate as an SgNB or an Sng-eNB. The UE 102 can communicate with the base station 104 and the base station 106A or 106B via the same radio access technology (RAT), such as EUTRA or NR, or via different RATs.

When the base station 104 is an MeNB and the base station 106A is an SgNB, the UE 102 can be in EN-DC with the MeNB 104 and the SgNB 106A. When the base station 104 is an Mng-eNB and the base station 106A is an SgNB, the UE 102 can be in next generation (NG) EUTRA-NR DC (NGEN-DC) with the Mng-eNB 104 and the SgNB 106A. When the base station 104 is an MgNB and the base station 106A is an SgNB, the UE 102 can be in NR-NR DC (NR-DC) with the MgNB 104 and the SgNB 106A. When the base station 104 is an MgNB and the base station 106A is an Sng-eNB, the UE 102 can be in NR-EUTRA DC (NE-DC) with the MgNB 104 and the Sng-eNB 106A.

With continued reference to FIG. 1A, the CN 110 communicatively connects the UE 102, to an MBS network 170, via the RAN 105. The MBS network 170 can provide to the UE 102 multicast and/or broadcast services (MBS) to UEs that can be useful in many content delivery applications, such as transparent IPv4/IPv6 multicast delivery, IPTV, software delivery over wireless, group communications, IoT applications, V2X applications, and emergency messages related to public safety. To this end, an entity (e.g., a server or a group of servers) operating in the MBS network 170 supports packet exchange with the UE. The packets can convey signaling (such as session initiation protocol (SIP) messages, IP messages, or other suitable messages) as well as data (“or media”) such as text messages, audio and/or video.

FIG. 1B depicts an example, distributed implementation of any one or more of the base stations 104, 106A, 106B. In this implementation, the base station 104, 106A, or 106B includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The processing hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172 and/or radio resource control (RRC) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit the non-MBS control information and MBS control information, and the CU-UP 172B can transmit the non-MBS data packets and MBS data packets, as described herein.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

FIG. 2 illustrates, in a simplified manner, an example protocol stack 200 according to which the UE 102 can communicate with an eNB/ng-eNB or a gNB (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets”. The packets can be MBS packets or non-MBS packets. For example, the MBS packets include MBS data packets including application content for an MBS service (e.g., IPv4/IPv6 multicast delivery, IPTV, software delivery over wireless, group communications, IoT applications, V2X applications, and/or emergency messages related to public safety). In another example, the MBS packets include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as an MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer, a split bearer, or an MN-terminated SCG bearer. The SN-terminated bearer can be an SCG bearer, a split bearer, or an SN-terminated MCG bearer. The MN-terminated bearer can be an SRB (e.g., SRB1 or SRB2) or a DRB. The SN-terminated bearer can be an SRB or a DRB.

In some implementations, a base station (e.g., base station 104, 106A or 106B) broadcasts MBS data packets via one or more MBS radio bearers (MRB(s)), and in turn the UE 102 receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102 uses PHY sublayer 202, MAC sublayer 204, and RLC sublayer 206 to receive the MBS data packets. In such implementations, the base station and the UE 102 may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102 uses PHY sublayer 202, MAC sublayer 204, RLC sublayer 206 and PDCP sublayer 208 to receive the MBS data packets. In such implementations, the base station and the UE 102 may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204 and PHY sublayer 202, and correspondingly, the UE 102 uses PHY sublayer 202, MAC sublayer 204, RLC sublayer 206, PDCP sublayer 208, and the SDAP sublayer 212 to receive the MBS data packets.

To simplify the following description, the UE 102 represents the UE 102A and the UE 102B, unless explicitly described.

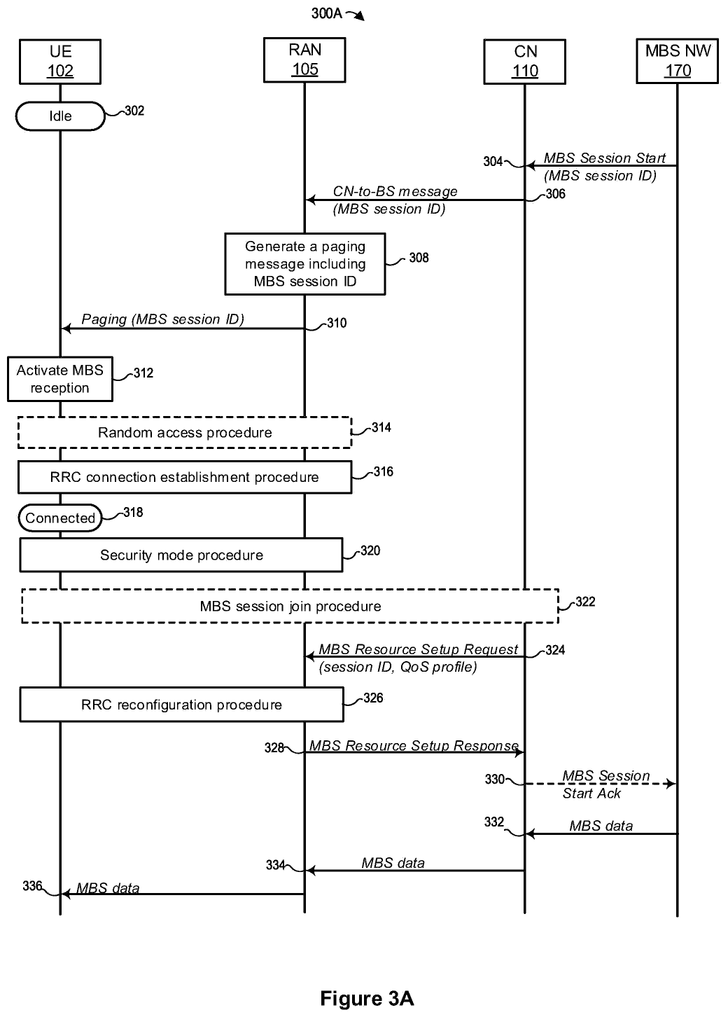

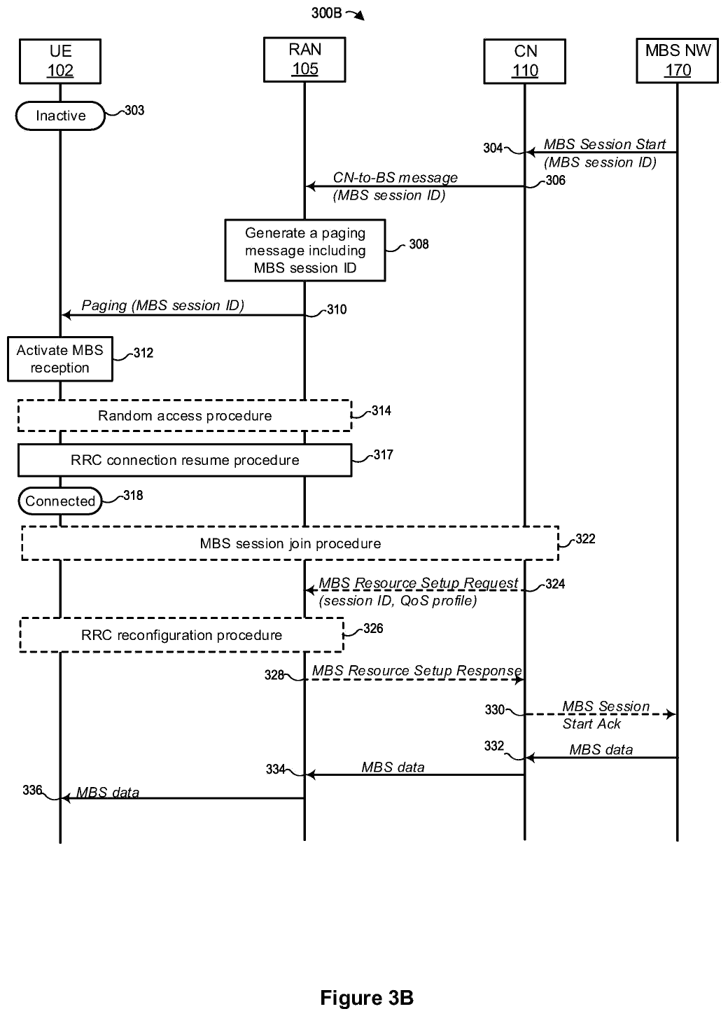

FIGS. 3A and 3B are messaging diagrams of example scenarios in which one or more UEs, the RAN, the CN and the MBS network implement the techniques of this disclosure for managing MBS transmission and reception. Generally speaking, events in FIGS. 3A and 3B that are similar are labeled with similar reference numbers, with differences discussed below where appropriate. With the exception of the differences shown in the figures and discussed below, any on the alternative implementations discussed with respect to a particular event (e.g., for messaging and processing) may apply to events labeled with similar reference numbers in other figures.

Now referring to a scenario 300A illustrated in FIG. 3A, UE 102 (e.g., the UE 102A and/or UE 102B) initially operates 302 in an idle state (e.g., RRC_IDLE state) with RAN 105. In the following description, the RAN 105 can represent base station 104, base station 106, cell 124 of the base station 104 and/or cell 126 of the base station 106). For example, the UE 102 operating in the idle state or the inactive state camps on a cell 124 of base station 104 of the RAN 105. MBS network 170 sends 304 an MBS Session Start message (or called MBS Session Start Request message) to CN 110 (e.g., AMF 164) to requests activation of an MBS session. The MBS network 170 includes an MBS session ID to identifying the MBS session in the MBS Session Start message. In some implementations, the MBS session ID is allocated by the CN 110. In other implementations, the MBS session ID is allocated by the MBS network 170. In some implementations, the MBS session ID can be or include a Temporary Mobile Group Identity (TMGI). In other implementations, the MBS session ID can be associated with a TMGI.

In response to the MBS Session Start message, the CN 110 can notify UEs of activation of the MBS session. To notify UEs of the MBS session activation, the CN 110 generates a CN-to-BS message including the MBS session ID and sends 306 the CN-to-BS message to the RAN 105. In some implementations, the CN-to-BS message can be an existing or new next generation application protocol (NGAP) message defined in 3GPP specification 38.413. For example, the existing NGAP message can be a NGAP Paging message. In other implementations, the CN-to-BS message can be a 6G application protocol (6GAP) message.

Upon receiving 306 the CN-to-BS message, the RAN 105 extracts the MBS session ID from the CN-to-BS message and generates 308 a paging message including the MBS session ID. Then the RAN 105 transmits 310 (i.e., via broadcast) the paging message, e.g., on the cell 124. In some implementations, the RAN 105 can transmit the paging message on a paging control channel (PCCH). In some implementations, the RAN 105 can generate a DCI and a CRC of the DCI from the DCI to transmit the paging message. The RAN 105 scrambles the CRC with a paging radio network temporary identifier (P-RNTI). The RAN 105 can include a downlink assignment in the DCI, which indicates a radio resource for a transmission of the paging message. The RAN 105 can transmit the DCI and the scrambled CRC on a PDCCH on the cell 124 to the UE 102 and the transmit the paging message on the indicated radio resource. When the UE 102 receives the DCI and the scrambled CRC on the PDCCH, the UE 102 verifies the scrambled CRC with the P-RNTI. If the UE 102 verifies the scrambled CRC is valid, the UE 102 receives or attempts to receive 310 the paging message on the radio resource in accordance with the DCI.

After or in response to receiving 310 the paging message, the UE 102 in the idle state activates (e.g., initiates) 312 reception of the MBS session identified by the MBS session ID. Alternatively, the UE 102 may activate 312 reception of the MBS session in response to receiving information on a multicast control channel (MCCH) (i.e., MCCH information) from the RAN 105, instead of receiving the paging message including the MBS session ID. The RAN 105 may broadcast or multicast the MCCH information.

In response to the activation 312, the UE 102 can perform 316 a RRC connection establishment procedure with the RAN 105. The UE 102 transitions 318 to a connected state (e.g., RRC_CONNECTED state) in response to the RRC connection establishment procedure. To perform 316 the RRC connection establishment procedure, the UE 102 can perform 314 a random access procedure with the RAN 105 to synchronize with the RAN 105 in uplink transmission, in cases where the UE 102 is not uplink synchronized with the RAN 105 (i.e., the UE 102 does not have a valid timing advance command or value with the RAN 105). The random access procedure can be a two-step or four-step random access procedure. To perform 316 the RRC connection establishment procedure, the UE 102 transmits a RRC request message (e.g., RRCSetupRequest message or RRCConnectionRequest message) to the RAN 105. In cases where the UE 102 performs 314 the two-step random access procedure, the UE 102 can transmit the RRC request message in a message A of the two-step random access procedure. In cases where the UE 102 performs 314 the four-step random access procedure, the UE 102 can transmit the RRC request message in a message 3 of the four-step random access procedure. In cases where the UE 102 is uplink synchronized with the RAN 105 and has a configured grant configuration for the idle state, the UE 102 can skip or omit the random access procedure. In such cases, the UE 102 can transmit the RRC Request message using a configured grant configured by the configured grant configuration. In response to the RRC request message, the RAN 105 can transmit a RRC response message (e.g., RRCSetup message or RRCConnectionSetup message) to the UE 102. In response, the UE 102 transitions 318 to the connected state and transmits a RRC complete message (e.g., RRCSetupComplete message or RRCConnectionSetupComplete message) to the RAN 105. In some implementations, the UE 102 configures a first SRB (e.g., SRB1) to communicate RRC messages with the RAN 105 in response to the RRC response message. In such implementations, the UE 102 transmits the RRC complete message via the first SRB to the RAN 105. In some implementations, the UE 102 can send a Service Request message to the CN 110 via the RAN 105 after transitioning 318 to the connected state. In one implementation, the UE 102 can include the Service Request message in the RRC complete message. The RAN 105 retrieves the Service Request message from the RRC complete message sends a first BS-to-CN message (e.g., Initial UE Message message) including the Service Request message to the CN 110.

After performing 316 the RRC connection establishment procedure with the UE 102 or transitioning 318 to the connected state, the RAN 105 can perform 320 a security activation procedure (e.g., RRC security mode procedure) with the UE 102 to activate security (e.g., integrity protection/integrity check and/or encryption/decryption) on communication with the UE 102. In details, the RAN 105 can send a security activation command message (e.g., SecurityModeCommand message) to the UE 102, e.g., via the SRB, to perform 320 the security activation procedure. In response, the UE 102 activate security (e.g., integrity protection and/or encryption) on communication with the RAN 105 and transmits a security activation complete message (e.g., SecurityModeComplete) to the RAN 105, e.g., via the SRB. After activating the security, the RAN 105 can perform a RRC reconfiguration (not shown in FIG. 3A) with the UE 102 to configure a second SRB (e.g., SRB2) and/or a DRB to exchange RRC messages and/or NAS message with the UE 102.

After transitioning 318 to the connected state or performing 320 the security activation procedure, the UE 102 can perform 322 an MBS session join procedure (or called an MBS session activation procedure or MBS session establishment procedure) with the CN 110 via the RAN 105 to indicate that the UE 102 requests to join the MBS session. In some implementations, the UE 102 may (determine to) do so if the UE 102 does not have an MBS context for receiving the MBS session. In cases where the UE 102 has an MBS context for receiving the MBS session before receiving 310 the paging message, the UE 102 can skip, omit or refrain from performing the MBS session join procedure. To perform 322 the MBS session join procedure, the UE 102 can send an MBS session join request message (or called MBS session activation request message or MBS session establishment request message) to the CN 110 via the RAN 105. In response, the CN 110 can send an MBS session join accept message (or called MBS session activation accept message or MBS session establishment accept message) to the UE 102 via the RAN 105. In some implementations, the UE 102 can perform the MBS session join procedure after activating 320 the security. Thus, the MBS session join procedure is protected by the security. Upon receiving the MBS session join request message from the UE 102, the RAN 105 can send a second BS-to-CN message (e.g., Uplink NAS Transport message) including the MBS session join request message to the CN 110. In other implementations, the UE 102 can perform the MBS session join procedure after transitioning 318 to the connected state and before activating the security. In one implementation, the UE 102 can include the MBS session join request message in the RRC complete message. The RAN 105 retrieves the MBS session join request from the RRC complete message and sends the first BS-to-CN message including the MBS session join request message to the CN 110. In this implementation, the UE 102 may determine not to send the Service Request message.

Alternatively, the UE 102 can perform the MBS session join procedure with the MBS network 170 via the CN 110 and the RAN 105, instead of the CN 110. In such case, the CN 110 sends the MBS session join request message to the MBS network 170 and receives the MBS session join accept message from the MBS network 170, respectively.

In some implementations, the MBS context includes the MBS session ID. In further implementations, the MBS context can include a QoS profile of the MBS session, an IP address for the MBS session, and/or one or more MRB configurations configuring one or more MRBs.

After receiving 304 the MBS Session Start message, the CN 110 can send 324 an MBS resource setup request message (e.g., MBS Session Resource Setup Request message) including the MBS session ID to the RAN 105. In some implementations, the CN 110 can include in the MBS resource setup request message a quality of service (QoS) profile to indicate QoS parameters associated to the MBS session. In some implementations, the CN 110 sends the MBS resource setup request message in response to or after receiving the first BS-to-CN message or the second BS-to-CN message. In response to or after receiving the MBS resource setup request message, the RAN 105 can perform 326 a RRC reconfiguration procedure with the UE 102 to configure radio resources for the UE 102 to receive 394 MBS data of the MBS session. To perform 326 the RRC reconfiguration procedure, the RAN 105 sends a RRC reconfiguration message to the UE 102. The RAN 105 can include, in the RRC reconfiguration message, configuration parameters for the UE 102 to receive MBS data of the MBS session. In some implementations, the RAN 105 can set configuration parameters in accordance with the QoS profile. The UE 102 receives the MBS data in the MBS data transmission procedure 394 in accordance with the configuration parameters. In some implementations, the configuration parameters may include physical layer configuration parameters, MAC configuration parameters, RLC configuration parameters, PDCP configuration parameters, SDAP configuration parameters and/or MRB configuration parameters.

In response to the RRC reconfiguration message, the UE 102 can send a RRC reconfiguration complete message to the RAN 105. After or in response to receiving the MBS resource setup request message, the RAN 105 can send 328 an MBS resource setup response message (e.g., MBS Session Resource Setup Response message) to the CN 110. In some implementations, the RAN 105 can send the MBS resource setup response message to the CN 110 before or after receiving the RRC reconfiguration complete message. After receiving 328 the MBS resource setup response message, the CN 110 can send 330 an MBS Session Start Acknowledge message to the MBS network 170 in response to the MBS Session Start message.

After receiving 332 the MBS Session Start Acknowledge message, the MBS network 170 can send 332 MBS data (e.g., one or more MBS data packets) to the CN 110, which in turn send 334 the MBS data to the RAN 105. The RAN 105 can transmit (e.g., via broadcast or multicast) 336 the MBS data to the UE 102. After performing the RRC reconfiguration procedure, the UE 102 in the connected state uses the configuration parameters to receive 336 the MBS data from the RAN 105.

In some implementations, the RAN 105 can broadcast barring control information for an access barring check. In some implementations, the barring control information may include one or more access categories and/or one or more access identities for a PLMN selected by the UE 102. Based on the barring control information, the UE 102 can perform an access barring check to determine whether an access attempt for reception of the MBS session is allowed. More specifically, the UE 102 can determine whether to perform 316 the RRC connection establishment procedure with the RAN 105 as a result of the access barring check. If the UE 102 passes the access barring check (i.e., the access barring check indicates that an access attempt for reception of the MBS session is allowed), the UE 102 performs 316 the RRC connection establishment procedure. If the UE 102 fails the access barring check (i.e., the access barring check indicates that an access attempt for reception of the MBS session is not allowed), the UE 102 terminates (e.g., stops or aborts) or refrains from performing the RRC connection establishment procedure.

To perform the access barring check, the UE 102 can determine an access category for the MBS session. The UE 102 performs the access barring check with the access category. In some implementations, the UE 102 determines (or identifies) the access category for the MBS session ID in accordance with a configuration stored in the UE. The configuration may include a mapping of the MBS session ID and the access category. For example, the UE 102 may receive the configuration from an operator's server or a core network via the RAN or another communication technology (e.g., WiFi). In another example, the UE 102 may obtain the configuration from a universal subscriber identity module (USIM) of the UE 102. In yet another example, the UE 102 may be pre-configured with the configuration in non-volatile memory of the UE during manufacturing.

In some implementations, the UE performs the access barring check in accordance with an access identity and/or the access category. In one implementation, the UE can obtain the access identity from the USIM. If the barring control information indicate access attempts with the access identity are allowed, the UE 102 determines the access attempt for the access category (i.e., receiving the MBS session) as allowed. Otherwise, if the barring control information the UE 102 can draw a random number, e.g., uniformly distributed in a range: 0≤rand<1. If the random number is lower than a value (e.g., barring factor for the access category) indicated in the barring control information, the UE 102 determines the access attempt for the access category (i.e., receiving the MBS session) as allowed. That is, the UE 102 passes the access barring check. Otherwise, the UE 102 determines the access attempt for the access category as barred. That is, the UE 102 fails the access barring check.

In cases where the UE 102 determines the access attempt as barred, the UE 102 may start a barring timer for the access category in response to the determination. In some implementations, the UE 102 can receive a timer value for the barring timer from the RAN 105, e.g., from system information broadcast by the RAN 105. In other implementations, the UE 102 can obtain (e.g., calculate or derive) a timer value from configuration parameters in system information broadcast by the RAN 105. During the barring timer running, the UE refrains from activating (or initiating) reception of an MBS associated to the access category. After the barring timer expires, the UE 102 may activate reception of the MBS session again and performs another access barring check as described above.

Turning to FIG. 3B, a scenario 300B is similar to the scenario 300A, except that the UE 102 initially operates 303 in an inactive state (e.g., RRC_INACTIVE). In some scenarios and implementations, the UE 102 was in a connected state with the RAN 105, before the UE 102 operates 303 in the inactive state. The UE 102 in the connected state communicates data with the RAN 105, e.g., via one or more radio bearers (RBs). In some implementations, the UE 102 in the connected state communicates the control-plane (CP) data via one or more signaling RBs (SRBs). In some implementations, the UE 102 in the connected state communicates the user-plane (UP) data via one or more data RBs (DRBs). After a certain period of data inactivity for the UE 102, the RAN 105 can determine that neither the RAN 105 nor the UE 102 has transmitted any data in the downlink direction or the uplink direction, respectively, during the certain period. In response to the determination, the RAN 105 can transmit a RRC release message (e.g., RRCRelease message or RRCConnectionRelease message) to the UE 102 and instruct the UE 102 to transition to the inactive state. The UE 102 transitions to the inactive state upon receiving the RRC release message. The RAN 105 can assign an I-RNTI or a resume ID to the UE 102 and include the assigned value in the RRC release message. In some embodiments, after the UE 102 transitions to the inactive state, the UE 102 may perform one or more RAN notification area (RNA) updates with the RAN 105 without state transitions.

After or in response to receiving 310 the paging message, the UE 102 in the inactive state activates (e.g., initiates) 312 reception of the MBS session in accordance with the MBS session ID. In response to the activation 312, the UE 102 can perform 317 a RRC resume procedure with the RAN 105. The UE 102 transitions 318 to a connected state (e.g., RRC_CONNECTED state) in response to the RRC resume procedure. To perform 317 the RRC resume procedure, the UE 102 can perform 314 a random access procedure with the RAN 105 to synchronize with the RAN 105 in uplink transmission, in cases where the UE 102 is not uplink synchronized with the RAN 105 (i.e., the UE 102 does not have a valid timing advance command or value with the RAN 105). The random access procedure can be a two-step or four-step random access procedure. To perform 317 the RRC resume procedure, the UE 102 transmits a RRC request message (e.g., RRCResumeRequest message or RRCConnectionResumeRequest message) to the RAN 105. In cases where the UE 102 performs 314 the two-step random access procedure, the UE 102 can transmit the RRC request message in a message A of the two-step random access procedure. In cases where the UE 102 performs 314 the four-step random access procedure, the UE 102 can transmit the RRC request message in a message 3 of the four-step random access procedure. In cases where the UE 102 is uplink synchronized with the RAN 105 and has a configured grant configuration for the idle state, the UE 102 can skip or omit the random access procedure. In such cases, the UE 102 can transmit the RRC request message using a configured grant configured by the configured grant configuration. In response to the RRC request message, the RAN 105 can transmit a RRC response message (e.g., RRCResume message or RRCConnectionResume message) to the UE 102. In response, the UE 102 transitions 318 to the connected state and transmits a RRC complete message (e.g., RRCResumeComplete message or RRCConnectionResumeComplete message) to the RAN 105. In some implementations, the UE 102 operating 303 in the inactive state suspends a first SRB (e.g., SRB1), a second SRB and/or one or more DRBs. In such implementations, the UE 102 resumes the first SRB to receive the RRC response message in response to or after transmitting the RRC request message and transmits the RRC complete message via the first SRB to the RAN 105. The UE 102 can resume the second SRB in response to the RRC response message. In some implementations, the UE 102 resumes the one or more DRBs in response to the RRC response message, in cases where the RAN 105 does not indicate release of the one or more DRBs. In some implementations, the UE 102 may not send a Service Request message to the CN 110 via the RAN 105 after transitioning 318 to the connected state, unlike FIG. 3A.

In some implementations, the UE 102 operating 303 in the inactive state has an MBS context for the MBS session as described for FIG. 3A. The UE 102 in the inactive state suspends one or more MRBs in the MBS context. In such implementations, the UE 102 resumes one or more MRBs in response to the RRC response message, in cases where the RAN 105 does not indicate release of the one or more MRBs in the RRC response message.

In some implementations, the UE 102 can receive 336 MBS data of the MBS session (i.e., a first MBS session) via (one, some or all of) the one or more MRBs that the UE 102 resumed in response to the RRC resume procedure. In such implementations, the UE 102 refrains from performing an MBS session join procedure to active reception of the MBS session. In other implementations, the UE 102 performs 322 the MBS session join procedure, in cases where the UE 102 does not have an MBS context for the MBS session. In some scenarios and implementations, the UE 102 may have an MBS context for a second MBS session and resumes one or more MRBs for the second MBS session in response to the RRC resume procedure or the RRC response message. In such cases, the UE 102 cannot receive MBS data of the first MBS session via the one or more MRBs of the MBS context for the second MBS session.

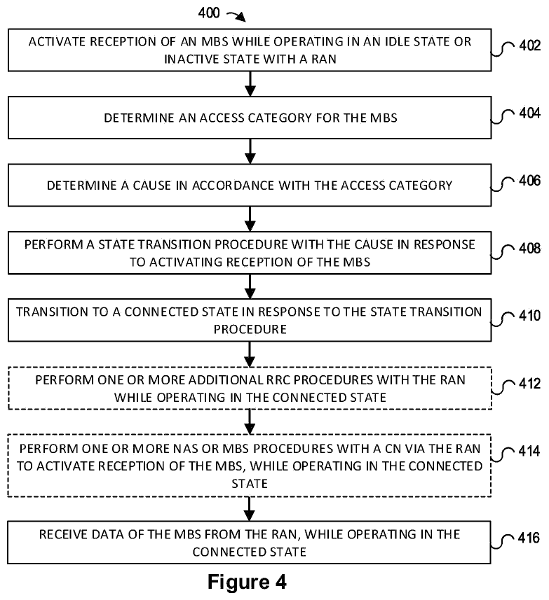

FIGS. 4-10 are flow diagrams depicting example methods that a UE (e.g., the UE 102A or the UE 102B) can implement to manage reception of an MBS. FIG. 11 is a flow diagram depicting an example method that a RAN (e.g., the base station 104 or the CU 172) can implement to manage transmission of an MBS.

FIG. 4 is a flow diagram of an example method 400 for managing reception of an MBS. At block 402, the UE activates reception of an MBS (e.g., an MBS session) while operating in an idle state or inactive state with a RAN (e.g., event 312). In some implementations, the UE activates reception of the MBS in response to receiving a paging message. In other implementations, the UE activates reception of the MBS because the UE determines to receive the MBS.

At block 404, the UE determines an access category for the MBS. At block 406, the UE determines a cause in accordance with the access category. At block 408, the UE performs a state transition procedure with the cause in response to activating reception of the MBS (e.g., events 316, 317). At block 410, the UE transitions to a connected state in response to the state transition procedure (e.g., event 318). At block 412, the UE can optionally perform one or more additional RRC procedures with the RAN while operating in the connected state (e.g., events 320, 326). At block 414, the UE can optionally perform one or more NAS or MBS procedures with a CN via the RAN to activate reception of the MBS, while operating in the connected state (e.g., event 322). At block 416, the UE receives data of the MBS from the RAN, while operating in the connected state (e.g., event 336).

In some implementations, the cause can indicate mobile terminating access. In other implementations, the cause can indicate mobile originating data. In yet other implementations, the cause can indicate a mobile originating voice call or a mobile originating video call. In further implementations, the cause can indicate reception of an MBS. In still further implementations, the cause can indicate priority access for multimedia priority service (MPS) or mission critical service (MCS).

In some implementations, the RAN can prioritize or configure resources for an MBS in accordance with the cause (value) that the RAN receives from the UE in a request message of the state transition procedure.

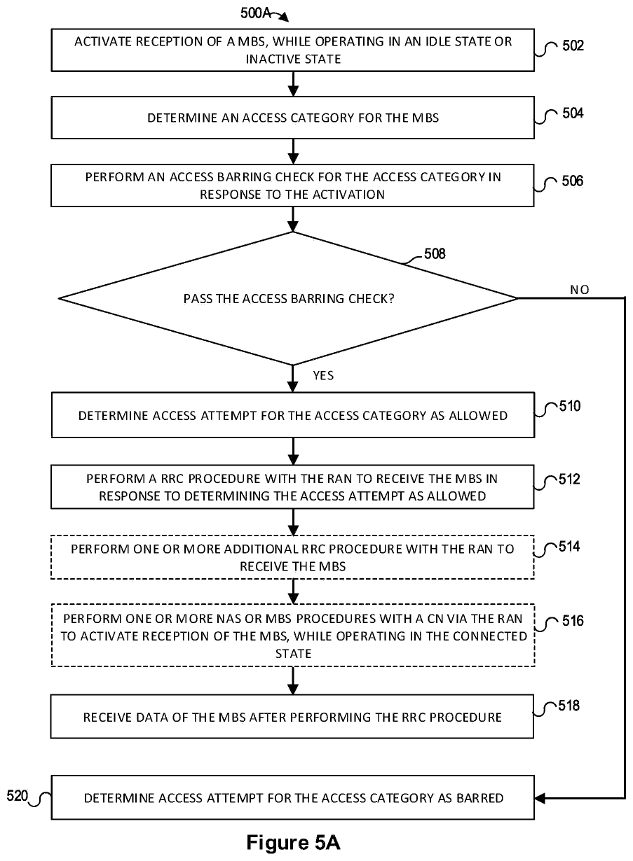

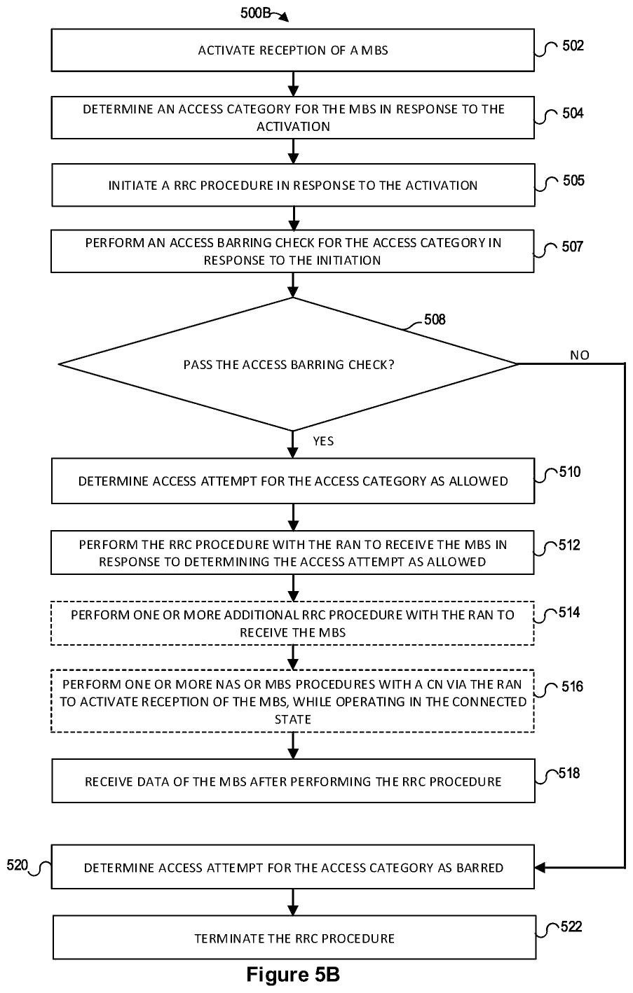

Blocks in FIGS. 5A-5B that are the same are labeled with the same reference numbers.

FIG. 5A is a flow diagram of an example method 500A for managing reception of an MBS. At block 502, the UE activates reception of an MBS (e.g., an MBS session), while operating in an idle state or an inactive state with a RAN (e.g., event 312). At block 504, the UE determines (or identifies) an access category for the MBS. At block 506, the UE performs an access barring check for the access category, in response to the activation of block 502. At block 508, the UE determines whether to pass the access barring check (i.e., whether the UE is allowed to perform an access attempt with the RAN). If the UE passes the access barring check, the flow proceeds to block 510. At block 510, the UE determines an access attempt with the access category as allowed at block 510. At block 512, the UE performs a RRC procedure with the RAN to receive the MBS in response to determining the access attempt as allowed (e.g., events 316, 317). At block 514, the UE can optionally perform one or more additional RRC procedures with the RAN to receive the MBS (evens 320, 326). At block 516, the UE can optionally perform one or more NAS or MBS procedures with a CN via the RAN to activate reception of the MBS, while operating in the connected state (e.g., event 322). At block 518, the UE receives data of the MBS after performing the RRC procedure (e.g., event 336). If the UE passes the access barring check, the flow proceeds to block 520. At block 520, the UE determines an access attempt for the access category as barred.

In some implementations, the UE at block 504 determines (or identifies) the access category for the MBS in accordance with a configuration stored in the UE. The configuration may include a mapping of the MBS and the access category. For example, the UE may receive the configuration from an operator's server or a core network via the RAN or another communication technology (e.g., WiFi). In another example, the UE may obtain the configuration from a universal subscriber identity module (USIM) of the UE. In yet another example, the UE may be pre-configured with the configuration in non-volatile memory of the UE during manufacturing. In some implementations, the UE at block 506 performs the access barring check in accordance with an access identity in addition to the access category that the UE determined at block 504. In one implementation, the UE can obtain the access identity from the USIM.

In some implementations, the UE starts a barring timer for the access category in response to the determination that the UE made at block 520. During the barring timer running, the UE refrains from activating (or initiating) reception of an MBS associated to the access category.

When the UE activates (e.g., initiates or determines to activate) a unicast service, the UE performs the access barring check for the unicast service, in some implementations. In other words, the access barring check is not only applied to an MBS but also to a unicast service. The UE can receive configuration parameters for the access barring check from the RAN and applies the configuration parameters when performing the access barring check.

In other implementations, the access barring check can be an MBS access barring check specific to one or more MBS (MBS(s)) including the MBS that the UE activates. In such implementations, the access barring check can be different from an access barring check for unicast service(s). The UE can receive configuration parameters for the MBS access barring check from the RAN and applies the configuration parameters when performing the access barring check. When the UE activates (e.g., initiates or determines to activate) a unicast service, the UE refrains from performing the MBS access barring check for the unicast service. In cases where the UE can receive configuration parameters for a unicast access barring check from the RAN, the UE applies the configuration parameters when performing the unicast access barring check for the unicast service.

FIG. 5B is a flow diagram of an example method 500B, which is similar to the method 500A. However, the UE at block 505 initiates the RRC procedure in response to the activation of block 502 (e.g., event 316, 317). The UE at block 507 performs an access barring check for the access category in response to the initiation of block 505. If the UE fails the access barring check, the UE at block 522 terminates the RRC procedure.

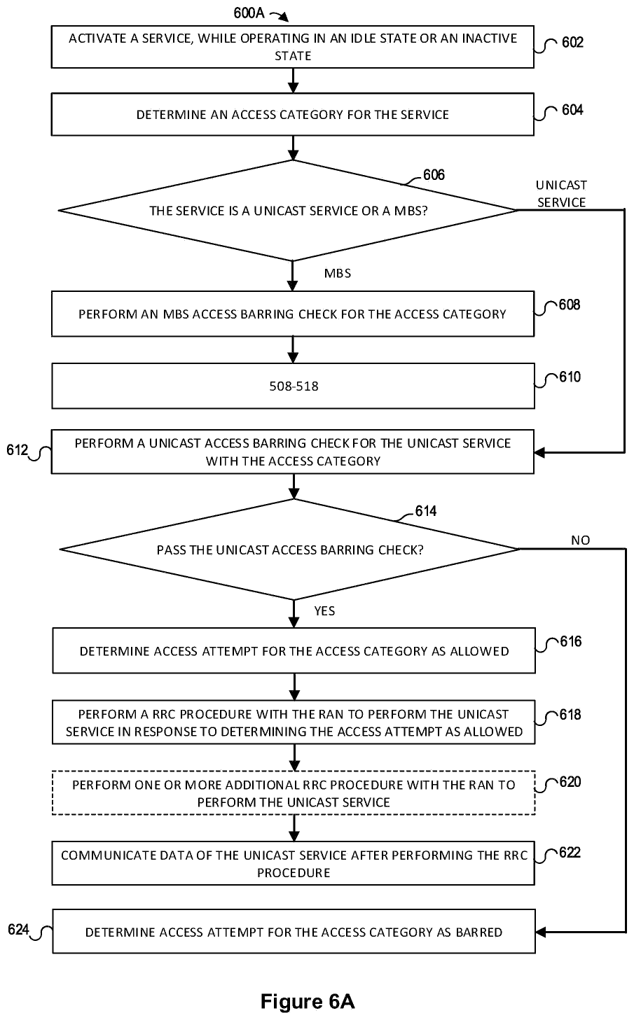

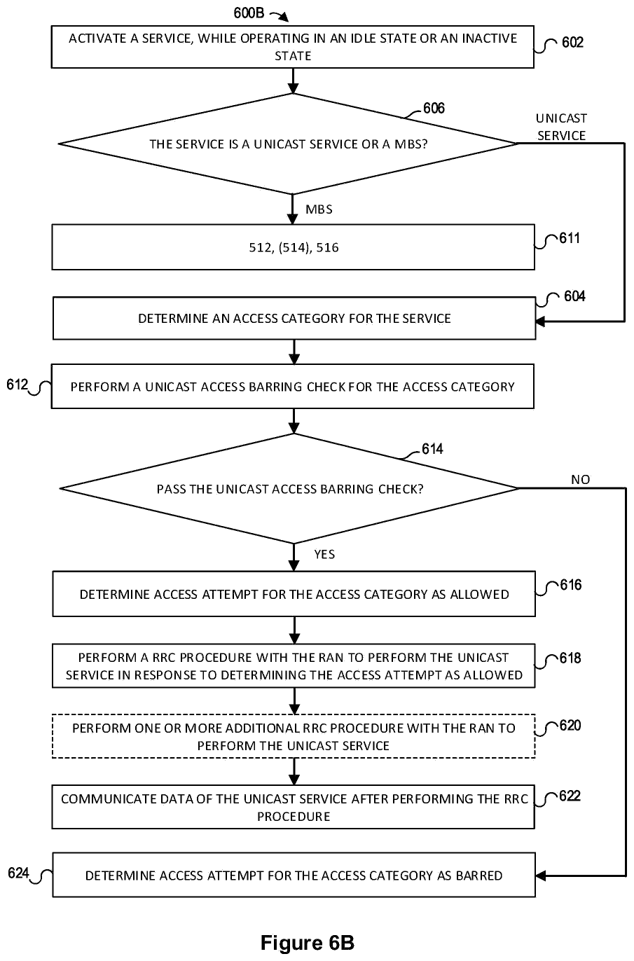

Blocks in FIGS. 6A-6B that are the same are labeled with the same reference numbers.

FIG. 6A is a flow diagram of an example method 600A for managing reception of an MBS. At block 602, the UE activates (e.g., initiates) a service, while operating in an idle state or an inactive state. At block 604, the UE determines an access category for the service. At block 606, the UE determines the service a unicast service or an MBS (e.g., MBS session). If the service is an MBS, the flow proceeds to block 608. At block 608, the UE performs an MBS access barring check for the access category. At block 610, the UE performs actions as described for 508-518. If the service is a unicast service, the flow proceeds to block 612. At block 612, the UE performs a unicast access barring check for the access category. At block 614, the UE determines whether to pass the unicast access barring check. If the UE passes the access barring check, the flow proceeds to block 616. At block 616, the UE determines an access attempt for the access category as allowed. At block 618, the UE performs a RRC procedure with the RAN to perform the unicast service in response to determining the access attempt as allowed. At block 620, the UE performs one or more additional RRC procedures with the RAN to perform the unicast service. At block 622, the UE communicates data of the unicast service after performing the RRC procedure. At block 624, the UE determines an access attempt with the access category as barred. For example, the RRC procedure is similar to event 316 or 317. The UE transitions to a connected state in response to the RRC procedure. In another example, the one or more additional RRC procedures are similar to events 320, 326.

FIG. 6B is a flow diagram of an example method 600B, which is similar to the method 600A. However, if the service is an MBS, the flow proceeds to block 611 instead of block 610. The UE at block 611 performs actions as described in block 512, 514 and 516, where the UE 102 can optionally perform block 514. In other words, the UE refrains from performing or does not perform an access barring check for an MBS. If the service is a unicast service, the flow proceeds to block 604.

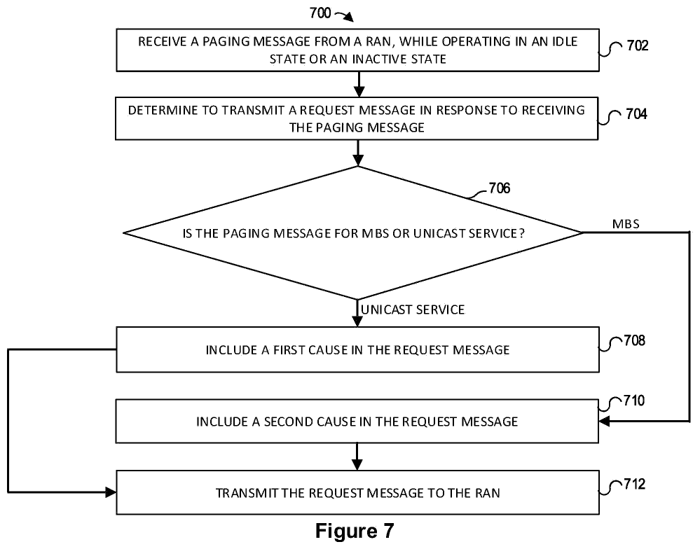

FIG. 7 is a flow diagram of an example method 700 for managing reception of an MBS. At block 702, the UE receives a paging message from a RAN, while operating in an idle state or AN inactive state (e.g., event 310). At block 704, the UE determines to transmit a request message in response to receiving the paging message (e.g., events 316, 317). At block 706, the UE determines whether the Paging message for MBS or unicast service. If the UE determines that the Paging message is for a unicast service, the flow proceeds to block 708. At block 708, the UE includes a first cause in the request message. If the UE determines that the Paging message is for an MBS, the flow proceeds to block 710. At block 710, the UE includes a second cause in the request message. At block 712, the UE transmits the request message to the RAN (e.g., events 316, 317).

In some implementations, the request message is a RRC request message (e.g., RRC setup request message or RRC resume request message). In cases where the UE in the idle state receives the paging message, the request message is an RRC setup request message (e.g., RRCSetupRequest message). In cases where the UE in the inactive state receives the paging message, the request message is an RRC resume request message (e.g., RRCResumeRequest message).

In some implementations, the UE sets the first cause to a value indicating mobile terminating access. In other implementations, the UE sets the second cause to a value other than mobile terminating access. For example, the UE can set the second cause to a value indicating mobile originating data. In another example, the UE can set the second cause to a value indicating MBS reception. In yet another example, the UE can set the second cause to a value indicating mobile originating signaling. In yet another example, the UE can set the second cause to a value indicating mobile originating video call. In yet another example, the UE can set the second cause to a value indicating mobile originating voice call.

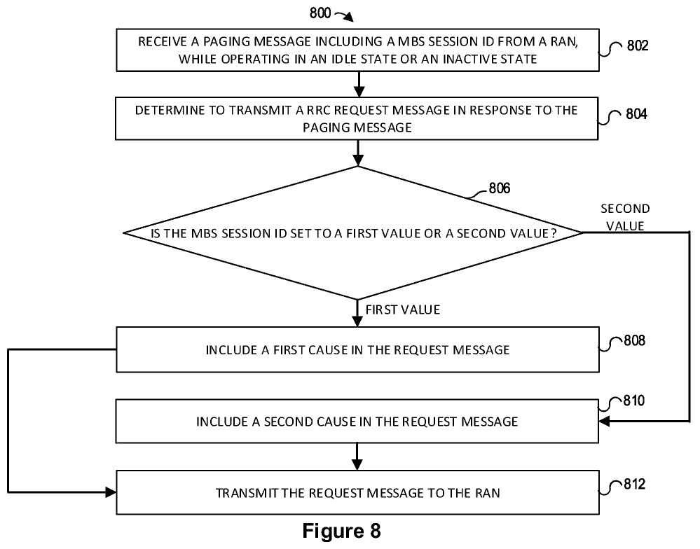

FIG. 8 is a flow diagram of an example method 800 for managing reception of an MBS. At block 802, the UE receives a paging message including an MBS session ID from a RAN, while operating in an idle state or AN inactive state (e.g., event 310). At block 804, the UE determines to transmit a RRC request message in response to receiving the paging message (e.g., events 316, 317). At block 806, Is the MBS session ID set to a first value or a second value? At block 808, the UE includes a first cause in the request message. At block 810, the UE includes a second cause in the request message. At block 812, the UE transmits the request message to the RAN (e.g., events 316, 317).

Example implementations of the request message are similar to the description for FIG. 7.

In some implementations, the first value (i.e., the first MBS session ID value) and the second value (i.e., the second MBS session ID value) can be associated with different MBSs. For example, the first value and the second value can be associated with a first MBS and a second MBS, respectively. Thus, the UE can (determine to) include the first cause or the second cause in the RRC Request message in accordance with which MBS that the MBS session ID is associated with. In cases where the first MBS is an audio service, the first cause can indicate an audio service or a voice service. In cases where the second MBS is a video service, the second cause can indicate a video service.

In other implementations, the first value (i.e., the first MBS session ID value) and the second value (i.e., the second MBS session ID value) can associate with different access categories. For example, the first value and the second value can be associated with a first access category and a second access category, respectively. Thus, the UE can (determine to) include the first cause or the second cause in accordance with which access category that the MBS session ID is associated with. The UE can store mapping information (e.g., mapping table) which maps a particular access category to a particular cause (value). Thus, the UE can determine a particular cause from the mapping information with a particular access category. For example, the UE determines the first cause from the mapping information with the first access category and determines the second cause from the mapping information with the second access category. In some implementations, the first and second causes can indicate any two of mobile terminating access, mobile originating signaling, mobile originating data, mobile originating voice, mobile originating video call, MPS priority access and/or MCS priority access.

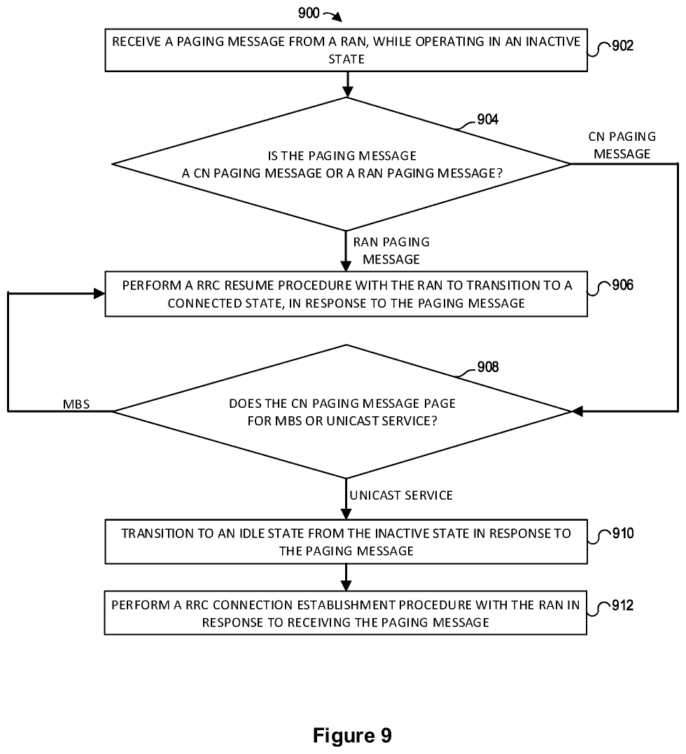

FIG. 9 is a flow diagram of an example method 900 for managing reception of an MBS. At block 902, the UE receives a paging message from a RAN, while operating in an inactive state (e.g., event 310). At block 904, the UE determines whether the paging message is a CN paging message (i.e., the CN triggers transmission of the paging message) or a RAN paging message (i.e., the RAN triggers transmission of the paging message). In some implementations, the RAN paging message includes a RAN ID. For example, the RAN ID can be an inactive radio network temporary identifier (I-RNTI) or a resume ID. In some implementations, the CN paging message can include a CN ID. For example, the CN ID can be an MBS session ID or a NAS ID of the UE. The NAS ID can be a 5G-S-TMSI.

If the paging message is a RAN paging message, the flow proceeds to block 906. At block 906, the UE performs a RRC resume procedure with the RAN to transition to a connected state, in response to the paging message (e.g., event 317). If the paging message is CN paging message, the flow proceeds to block 908. At block 908, the UE determines whether the CN paging message pages for an MBS or a unicast service. If the CN paging message pages for a unicast service, the flow proceeds to block 910. At block 910, the UE transitions to an idle state from the inactive state in response to the paging message. At block 912, the UE performs a RRC connection establishment procedure with the RAN in response to receiving the paging message (e.g., event 316). If the CN paging message pages for an MBS, the flow proceeds to block 906.

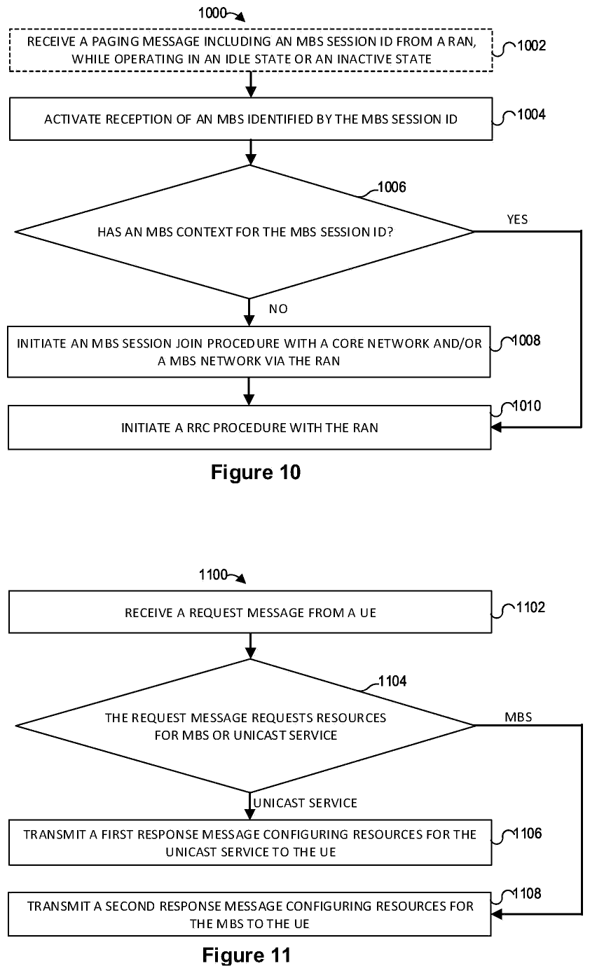

FIG. 10 is a flow diagram of an example method 1000 for managing reception of an MBS. At block 1002, the UE receives a paging message including an MBS session ID from a RAN, while operating in an idle state or an inactive state (e.g., event 310). At block 1004, the UE activates reception of an MBS identified by the MBS session ID (e.g., event 312). At block 1006, the UE determines whether the UE has an MBS context for (or associated with) the MBS session ID. If the UE does not have an MBS context for the MBS session ID, the flow proceeds to block 1008. At block 1008, the UE initiates an MBS session join procedure with a core network and/or an MBS network via the RAN (e.g., event 322) to receive the MBS. At block 1010, the UE initiates a RRC procedure with the RAN in response to the initiation. At block 1012, the UE initiates a RRC procedure with the RAN (e.g., events 316, 317). The UE transitions to a connected state in response to the RRC procedure. The UE in the connected state can optionally perform one or more additional RRC procedures with the RAN. After performing the MBS session join procedure with the CN or MBS network via the RAN, the UE in the connected state receives data of the MBS from the RAN.

If the UE does not have an MBS context for the MBS session ID, the flow proceeds to block 1010. At block 1010, the UE initiates a RRC procedure with the RAN to receive data of the MBS. In this case, the UE skips, omits or refrains from performing and/the MBS session join procedure for receiving the MBS. The UE transitions to a connected state in response to the RRC procedure. The UE in the connected state can optionally perform one or more additional RRC procedures with the RAN. The UE in the connected state receives data of the MBS from the RAN.

FIG. 11 is a flow diagram of an example method 1100 for managing transmission of an MBS. At block 1102, the RAN receives a request message from a UE (e.g., events 316, 317). At block 1104, the RAN determines the request message requests resources for an MBS or a unicast service. If the request message requests resources for a unicast service, the flow proceeds to block 1106. At block 1106, the RAN transmits a first response message configuring resources for the unicast service to the UE. If the request message requests resources for an MBS, the flow proceeds to block 1108. At block 1108, the RAN transmits a second response message configuring resources for the MBS to the UE (e.g., events 316, 317, 326).

In some implementations, the first response message includes first configuration parameters configuring resources for the unicast service and the second response message includes second configuration parameters configuring resources for the MBS. For example, the first configuration parameters include DRB configuration, PDCP configuration, RLC configuration, MAC configuration and/or physical layer configuration for communicating the unicast service. In another example, the. Second configuration parameters include DRB, PDCP configuration, RLC configuration, MAC configuration and/or physical layer configuration for receiving the MBS.

In some implementations, the first and second response messages can be the same RRC messages (e.g., RRC reconfiguration messages, RRC setup messages or RRC resume messages). In other implementations, the first and second response messages can be different RRC messages (e.g., RRC reconfiguration message, RRC setup message or RRC resume message).

In some implementations, the request message can be a RRC request message described for FIG. 3A or 3B. In some implementations, the request message can include a cause. The RAN can determine the request message requests resources for an MBS or a unicast service in accordance with the cause. For example, if the cause indicates reception of an MBS, the RAN can determine the request message requests resources for an MBS. If the cause indicates a unicast service, the RAN can determine the request message requests resources for a unicast service.

In some implementations, the RAN at block 1106 can instead send to the UE a reject message (e.g., RRC reject message or RRC release message) to reject allocating resources for the unicast service in cases where the RAN is busy. In such cases, the RAN allows to allocate resources for the MBS. The RAN can determine it is busy based on one or more criteria. For example, if total resources of the RAN have been occupied over a predetermined threshold, the RAN determines it is busy.

The following additional considerations apply to the foregoing discussion.

In some implementations, “MBS” can be replaced by “MBS session” or vice versa. In some implementations, “message” is used and can be replaced by “information element (IE)”. In some implementations, “IE” is used and can be replaced by “field”. In some implementations, “configuration” can be replaced by “configurations” or the configuration parameters.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

What is claimed is:

1. A method in a UE for managing reception of Multicast and Broadcast Services (MBS) data, the method comprising:
receiving, from a radio access network (RAN), a paging message including an MBS session identifier (ID), the MBS session ID including a Temporary Mobile Group Identity (TMGI); and
initiating reception of MBS in response to the paging message.

2. The method of claim 1, further comprising:
performing an access barring check subsequently to receiving the paging message.

3. The method of claim 2, wherein performing the access barring check includes:
determining an access category for MBS; and
performing the access barring check in accordance with the category.

4. The method of claim 3, wherein determining the access category includes using a configuration including a mapping of the MBS and the access category, stored in the UE.

5. The method of claim 3, wherein determining the access category includes using a configuration received from a core network (CN).

6. The method of claim 3, wherein determining the access category includes using a configuration received from a universal subscriber identity module (USIM) of the UE.

7. The method of any of claims 3-7, further comprising:
determining a cause in accordance with the access category, the cause indicating mobile terminating (MT) access.

8. The method of any of claims 3-7, further comprising:
determining a cause in accordance with the access category, the cause indicating reception of MBS.

9. The method of claim 8 or 9, further comprising:
configuring resources for the MBS in accordance with the cause.

10. The method of any of the preceding claims, further comprising:
performing a join procedure for an MBS session corresponding to the MBS session ID.

11. The method of any of the preceding claims, further comprising:
determining, subsequent to receiving the paging message, that the UE has an MB context for an MBS session corresponding to the MBS session ID; and
in response to the determining, initiating a radio resources controls (RRC) procedure with the RAN.

12. The method of any of claims 1-6, further comprising:
determining, subsequent to receiving the paging message, that the UE does not have an MB context for an MBS session corresponding to the MBS session ID; and
in response to the determining, initiating a join procedure for an MBS session corresponding to the MBS session ID.

13. The method of claim 1, further comprising:
operating in a connected RRC state when the paging message is received.

14. The method of claim 1, further comprising:
operating in an inactive RRC state when the paging message is received.

15. A UE comprising one or more processors and configured to implement a method according to any of the preceding claims.
